(19) United States
(12) Patent Application Publication
(10) Pub. No.: US 2021/0329197 A1
(43) Pub. Date: Oct. 21, 2021

(54) Hand-Up Initiating and Responding Method and Interactive System in Multi-Party Video Activity

(71) Applicant: EEO Education Technology Co. Ltd, Beijing (CN)

(72) Inventors: Xiaoyong ZHANG, Beijing (CN); Qian HE, Beijing (CN)

(73) Assignee: EEO Education Technology Co. Ltd, Beijing (CN)

(21) Appl. No.: 17/275,679

(22) PCT Filed: Jun. 15, 2020
(86) PCT No.: PCT/CN2020/096056

§ 371 Date: Mar. 12, 2021

(30) Foreign Application Priority Data
Jan. 22, 2020 (CN) 202010074221.9

(51) Int. Cl. H04N 7/15; H04L 29/06

(52) U.S. Cl. CPC H04N 7/15; G06F 3/0482; H04L 65/403

(57) ABSTRACT

A hand-up initiating and responding method and interactive system in a multi-party video activity are disclosed. The hand-up initiating method in a multi-party video activity includes: step 1) pressing a hand-up button, sending a hand-up message, and updating a hand-up status in a local video window and hand-up statuses in a local roster; step 2) releasing the hand-up button, and starting countdown; step 3) sending a hand-up cancellation message and updating the hand-up status in the local video window and the hand-up statuses in the local roster at the end of the countdown; and step 4) if the hand-up button is pressed again within the countdown time, skipping to step 2) without sending a hand-up message. The present invention provides a special interactive mode, in which when a participant raises a question, an initiator can perceive in real time and respond in time.

### RELATED APPLICATION

This application claims priority to Chinese patent application No. 202010074221.9, entitled “Hand-Up Initiating and Responding Method and Interactive System in Multi-Party Video Activity” filed on Jan. 22, 2020, which is incorporated herein by reference.

### FIELD OF THE INVENTION

The present invention relates to the field of online education/discussions, in particular to a hand-up initiating and responding method and interactive system in a multi-party video activity.

### BACKGROUND OF THE INVENTION

With continuous development of the Internet, one-to-many video activities have become very common. Once a larger number of participants are involved, handling work of an initiator becomes more complicated. The initiator must focus on his lecture, but also has to pay attention to questions put forward by the participants at any time. In some multi-party video activities, participants can directly report to the initiator by voice, but the initiator considers that if all participants are allowed to speak, echoes generated can influence the effect of the video activity, so most of the time the initiator mutes the participants, and the participants cannot report by voice if they have any questions. There is a chat function in some multi-party video activities. Participants ask questions by sending chat messages to the initiator. However, in the case of many chat messages, question messages of the participants are likely to be submerged in the numerous chat messages.

### SUMMARY OF THE INVENTION

An object of the present invention is to overcome the above-mentioned shortcomings of the prior art and propose a hand-up interactive method in a multi-party video activity.

To achieve the above object, the present invention proposes a hand-up initiating method in a multi-party video activity, the method including:

step 1) pressing a hand-up button, sending a hand-up message, and updating a hand-up status in a local video window and hand-up statuses in a local roster;

step 2) releasing the hand-up button, and starting countdown;

step 3) sending a hand-up cancellation message and updating the hand-up status in the local video window and the hand-up statuses in the local roster at the end of the countdown; and

step 4) if the hand-up button is pressed again within the countdown time, skipping to step 2) without sending a hand-up message.

As an improvement of the above-mentioned method, the hand-up message includes a participant's userID and a hand-up identifier.

As an improvement of the above-mentioned method, the hand-up cancellation message includes a participant's userID and a hand-up cancellation identifier.

The present invention further proposes a hand-up initiating system in a multi-party video activity, the system including;

a hand-up module configured to send a hand-up message and update a hand-up status in a local video window and hand-up statuses in a local roster when a hand-up button is pressed;

a hand-up cancellation module configured to start countdown when the hand-up button is released;

a countdown processing module configure to send a hand-up cancellation message and update the hand-up status in the local video window and the hand-up statuses in the local roster at the end of the countdown: and lead the process to the hand-up cancellation module without sending a hand-up message if the hand-up button is pressed again within the countdown time.

The present invention further proposes a hand-up responding method in a multi-party video activity, the method including:

lighting up a hand-up button and keeping the button flashing when receiving a hand-up message;

searching, in a hand-up list, for userID in the hand-up message; if the userID of a participant is not found, inserting the userID of the participant to the end of the hand-up list; otherwise, updating the hand-up list; and

determining a participant to be put on stage by pressing the hand-up button or clicking an entry in the hand-up list once, and displaying the participant's video.

As an improvement of the above-mentioned method, determining a participant to be put on stage by pressing the hand-up button or clicking an entry in the hand-up list once specifically includes:

determining a participant corresponding to an entry at the top of the hand-up list to be the participant to be put on stage by pressing the hand-up button; or

determining a participant corresponding to an entry in the hand-up list to be the participant to be put on stage by clicking the entry once.

As an improvement of the above-mentioned method, the hand-up list is configured to show current participant hand-up information, which is displayed from top to bottom according to the sequence of received participant hand-up messages, wherein information of each hand-up participant occupies one row of the list, the information including userID, the name of the participant, a hand-up status of the participant, and an on stage/off stage status of the participant, the hand-up status of the participant including hand-up and no hand-up.

As an improvement of the above-mentioned method, the method further includes: when receiving a hand-up cancellation message, based on userID in the hand-up cancellation message, changing the hand-up status of the participant corresponding to userID in the hand-up list to no hand-up.

The present invention further proposes a hand-up responding system in a multi-party video activity, the system including:

a hand-up message reception module configured to light up a hand-up button and keep the button flashing when receiving a hand-up message; and search, in a hand-up list, for userID in the hand-up message; if the userID of a participant is not found, insert the userID of the participant to the end of the hand-up list; otherwise, update the hand-up list; and

a hand-up message response module configured to determine a participant to be put on stage by pressing the hand-up button or clicking an entry in the hand-up list once, and display the participant's video.

The present invention further proposes a hand-up interactive system in a multi-party video activity, the system including:

a hand-up initiating system configure to send a hand-up message and update a hand-up status in a local video window and hand-up statuses in a local roster when a hand-up button is pressed; start countdown when the hand-up button is released; if the hand-up button is pressed again within the countdown time, the hand-up initiating module restarts the countdown without sending a hand-up message; otherwise, send a hand-up cancellation message and update the hand-up status in the local video window and the hand-up statuses in the local roster at the end of the countdown; and

a hand-up responding module configured to light up a hand-up button and keep the button flashing when receiving a hand-up message; search, in a hand-up list, for userID in the hand-up message; if the userID of a participant is not found, insert the userID of the participant to the end of the hand-up list; otherwise, update the hand-up list; and determine a participant to be put on stage by pressing the hand-up button or clicking an entry in the hand-up list once, and display the participant's video.

The present invention has the following advantages:

1. The present invention provides a special interactive mode, in which when a participant raises a question, an initiator can perceive in real time and respond in time.

2. In the present invention, when seeing the hand-up button flashing, the initiator directly clicks the hand-up button so that a hand-up participant can be directly allowed to speak, and with the hand-up list, the initiator can know which participants are raising their hands, and can directly operate to put one on/off stage, thus achieving simple and direct operations, and a good interactive effect of the video activity.

### BRIEF DESCRIPTION OF THE DRAWINGS

FIG. 1 is a schematic diagram of hand-up interaction in a multi-party video activity of the present invention;

FIG. 2 is a flow diagram of a hand-up initiating method in a multi-party video activity in an embodiment of the present invention;

FIG. 3 is a flow diagram of receiving a hand-up message in a hand-up responding method in a multi-party video activity in an embodiment of the present invention; and

FIG. 4 is a flow diagram of handling a hand-up message in a hand-up responding method in a multi-party video activity in an embodiment of the present invention.

### DETAILED DESCRIPTION OF THE EMBODIMENTS

The technical solutions of the present invention will be described in detail below in conjunction with the accompanying drawings and embodiments.

### Embodiment 1

This embodiment is applied to online discussion scenarios.

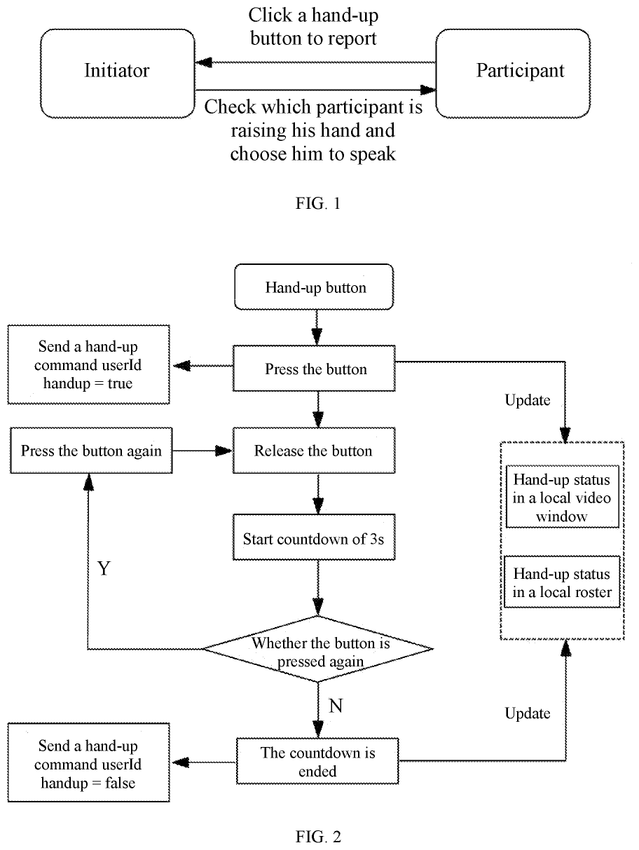

Hand-up buttons are respectively deployed on participant terminals and an initiator terminal of discussion, as shown in FIG. 1. At a participant terminal, a participant presses the hand-up button, applies for the stage, and sends a hand-up message to the initiator terminal. The hand-up message includes the participant's userID and a hand-up identifier. When the initiator terminal monitors a hand-up message, the hand-up button of the initiator terminal flashes. By checking a hand-up list, participants who are raising their hands are seen, including their sequence, and by clicking the hand-up button or selecting a participant in the hand-up list, which indicates that the initiator agrees that a certain participant can come on stage, the participant's video is displayed on each terminal.

If a hand-up participant releases the hand-up button, which indicates that the participant's hand-up operation is canceled, countdown is started (this scenario uses 3 seconds as an example, but is not limited to this value, which is set as needed in actual applications), and the participant terminal sends a hand-up cancellation message at the end of the countdown. The hand-up cancellation message includes userID and a hand-up cancellation identifier. When the initiator terminal receives the hand-up cancellation message, statuses in the hand-up list are updated, and the participant's hand-up status is changed to no hand-up. If a message indicating the hand-up button is pressed is received again within set time, a previous-hand-up cancellation message is not sent. A new hand-up message is not sent, and the hand-up status continues to be maintained.

The countdown is set in consideration of the possibility that in an online system, participants pressing and releasing the hand-up buttons may cause frequent flashing of the hand-up button of the initiator terminal, which affects normal discussions and causes network pressure. Therefore, countdown is started after a participant presses and releases the hand-up button, and a hand-up cancellation message is sent at the end of the countdown. If a message indicating the button is pressed is received again within set time, a previous-hand-up cancellation message is not sent.

An implementation of a hand-up button of a participant terminal:

As shown in FIG. 2:

1. A participant clicks the hand-up button once and does not release it, and the hand-up button is lighted up. At this time, the participant terminal encapsulates information with the user's userId and hand-up status handup=true as main parameters into a hand-up message, and sends the message to the initiator terminal via a network. When the participant clicks the button once and releases it, the hand-up button changes into a non-hand-up state. At this time, the participant terminal encapsulates information with userId and handup=false as main parameters into a hand-up cancellation message, and sends the message to the initiator terminal via the network.

2. The design of countdown of the hand-up button of the participant terminal is that using 3 seconds as an example, when the button of the participant terminal is clicked once and pressed without release, a hand-up message is sent, and the button is lighted up and comes into a hand-up state. When the participant releases the button, the button enters a countdown state, and a message indicating the participant has put down his hand is sent at the end of the countdown. During the 3-second countdown process, if the hand-up button is clicked again, the countdown is interrupted, and the button is lighted up again, and when button is released again, 3-second countdown is started again.

At the same time, the participant can see changes of his hand-up status in a video window and a “roster” in the participant terminal.

An implementation of a hand-up button of an initiator terminal:

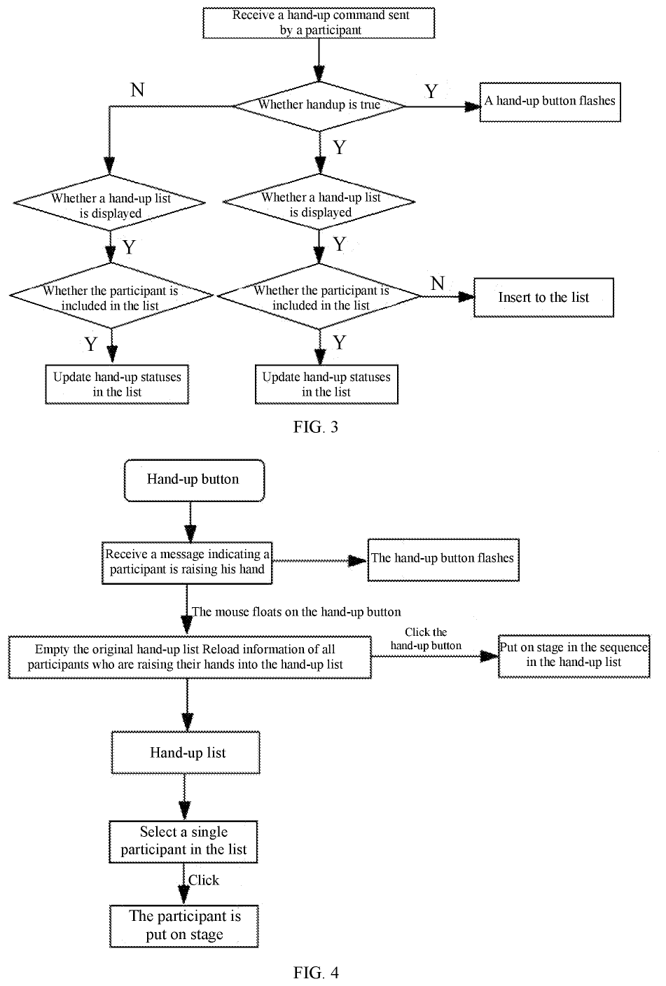

As shown in FIG. 3, after the initiator terminal receives a participant's hand-up command, a hand-up prompt tone is played, and the hand-up button starts to flash. The hand-up button is relatively large and keeps flashing, so the initiator can easily notice that a participant is raising his hand. At the same time, the initiator can also see the participant's hand-up status in the participant's video window and the “roster”.

As shown in FIG. 4, there are two ways for the initiator to handle a participant's hand-raising behavior. One is that a mouse floats on the hand-up button, so that a hand-up list pops up on the left side of the button; and the other is that the initiator can directly click the hand-up button.

1. Description of behaviors related to the hand-up list:

1) When the mouse floats on the hand-up button, a hand-up list pops up on the left side of the button. If the mouse of the initiator terminal keeps floating in the region of the hand-up list, the hand-up list is displayed all the time. When the mouse leaves the list region, the hand-up list disappears.

2) As to the content in the hand-up list, when the cursor floats on the hand-up button, the hand-up list is emptied, and information of all participants who are raising their hands is reloaded into the hand-up list, in which each item describes a participant's name, the participant's hand-up status, and the participant's on-stage/off-stage status. The hand-up list is displayed from top to bottom, and arranged in the order of receiving hand-up messages of the participants by the initiator terminal. Participants raising their hands later are inserted at the end of the list.

3) After the list pops up, when a participant in the list no longer raises his hand, a hand-up state in an item corresponding to the participant is canceled. When the participant raises his hand again, a new item is not added at the end of the list, but the hand-up status display is changed in the item corresponding to the participant.

4) When the initiator clicks an item, if the participant corresponding to the item is off stage, he will be put on stage after the item is clicked.

2. Description of behaviors related to the hand-up button:

When the mouse of the initiator terminal floats on the hand-up button, the flashes disappear. The initiator does not have to handle the participant's hand-raising behavior. He can choose to respond to the participant's hand-raising behavior, or he can ignore it. When the initiator directly clicks the flashing hand-up button once, the flashes disappear. If the participant at the top of the hand-up list is off stage, the participant will be put on stage. Clicking the hand-up button continuously can put on stage participants who are raising their hands but have not been put on stage, from top to bottom of the hand-up list.

### Embodiment 2

This embodiment is applied to online classroom scenarios.

Hand-up buttons are respectively deployed on student terminals and a teacher terminal, as shown in FIG. 1. At a student terminal, a student presses the hand-up button, applies for the stage, and sends a hand-up message to the teacher terminal. The hand-up message includes the student's userID and a hand-up identifier. When the teacher terminal monitors that there is a hand-up message, the hand-up button of the teacher terminal flashes. By checking a hand-up list, students who are raising their hands are seen, including their sequence, and by clicking the hand-up button or selecting a student in the hand-up list, which indicates that the teacher agrees that a certain student can come on stage, the student's video is displayed on each terminal.

If a hand-up student releases the hand-up button, which indicates that the student's hand-up operation is canceled, countdown is started (this scenario uses 3 seconds as an example, but is not limited to this value, which is set as needed in actual applications), and the student terminal sends a hand-up cancellation message at the end of the countdown. The hand-up cancellation message includes userID and a hand-up cancellation identifier. When the teacher terminal receives the hand-up cancellation message, statuses in the hand-up list are updated, and the student's hand-up status is changed to no hand-up. If a message indicating the hand-up button is pressed is received again within the countdown time, a previous-hand-up cancellation message is not sent. A new hand-up message is not sent, and the hand-up status continues to be maintained.

An implementation of a hand-up button of a student terminal:

As shown in FIG. 2:

1. A student clicks the hand-up button once and does not release it, and the hand-up button is lighted up. At this time, the student terminal encapsulates information with the user's userID and hand-up status handup=true as main parameters into a hand-up message, and sends the message to the initiator terminal via a network. When the student clicks the button once and releases it, the hand-up button changes into a non-hand-up state. At this time, the student terminal encapsulates information with userID and handup=false as main parameters into a hand-up cancellation message, and sends the message to the initiator terminal via the network.

An implementation of a hand-up button of a teacher terminal:

As shown in FIG. 3, after the teacher terminal receives a student's hand-up command, a hand-up prompt tone is played, and the hand-up button starts to flash. The hand-up button is relatively large and keeps flashing, so the teacher can easily notice that a student is raising his hand. At the same time, the teacher can also see the student's hand-up status in the student's video window and the “roster”.

As shown in FIG. 4, there are two ways for the teacher to handle a student's hand-raising behavior. One is that a mouse floats on the hand-up button, so that a hand-up list pops up on the left side of the button; and the other is that the teacher can directly click the hand-up button.

1. Description of behaviors related to the hand-up list:

1) When the mouse floats on the hand-up button, a hand-up list pops up on the left side of the button. If the mouse of the teacher terminal keeps floating in the region of the hand-up list, the hand-up list is displayed all the time. When the mouse leaves the list region, the hand-up list disappears.

2) As to the content in the hand-up list, when the cursor floats on the hand-up button, the hand-up list is emptied, and information of all students who are raising their hands is reloaded into the hand-up list, in which each item describes a student's name, the student's hand-up status, and the student's on-stage/off-stage status. The hand-up list is displayed from top to bottom, and arranged in the order of receiving hand-up messages of the students by the teacher terminal. Students raising their hands later are inserted at the end of the list.

3) After the list pops up, when a student in the list no longer raises his hand, a hand-up state in an item corresponding to the student is canceled. When the student raises his hand again, a new item is not added at the end of the list, but the hand-up status display is changed in the item corresponding to the student.

4) When the teacher clicks an item, if the student corresponding to the item is off stage, he will be put on stage after the item is clicked.

2. Description of behaviors related to the hand-up button:

When the mouse of the teacher terminal floats on the hand-up button, the flashes disappear. The teacher does not have to handle the student's hand-raising behavior. He can choose to respond to the student's hand-raising behavior, or he can ignore it. When the teacher directly clicks the flashing hand-up button once, the flashes disappear. If the student at the top of the hand-up list is off stage, the student will be put on stage. Clicking the hand-up button continuously can put on stage students who are raising their hands but have not been put on stage, from top to bottom of the hand-up list.

The present invention is not limited to online discussions and online classrooms, and may also be applied to other scenarios of multi-party video activities.

Finally, it should be noted that the above embodiments are only used for describing instead of limiting the technical solutions of the present invention. Although the present invention is described in detail with reference to the embodiments, persons of ordinary skill in the art should understand that modifications or equivalent substitutions of the technical solutions of the present invention should be encompassed within the scope of the claims of the present invention so long as they do not depart from the spirit and scope of the technical solutions of the present invention.

1. A hand-up initiating method in a multi-party video activity, the method comprising:
step 1) pressing a hand-up button, sending a hand-up message, and updating a hand-up status in a local video window and hand-up statuses in a local roster;
step 2) releasing the hand-up button, and starting countdown;
step 3) sending a hand-up cancellation message and updating the hand-up status in the local video window and the hand-up statuses in the local roster at the end of the countdown; and
step 4) if the hand-up button is pressed again within the countdown time, skipping to step 2) without sending a hand-up message; wherein
the hand-up message comprises a userID and a hand-up identifier of a participant;
the hand-up cancellation message comprises the userID and a hand-up cancellation identifier of the participant.

2. A hand-up initiating system in a multi-party video activity, the system comprising:
a hand-up module configured to send a hand-up message and update a hand-up status in a local video window and hand-up statuses in a local roster when a hand-up button is pressed;
a hand-up cancellation module configured to start countdown when the hand-up button is released;
a countdown processing module configure to send a hand-up cancellation message and update the hand-up status in the local video window and the hand-up statuses in the local roster at the end of the countdown; and lead the process to the hand-up cancellation module without sending a hand-up message if the hand-up button is pressed again within the countdown time; wherein
the hand-up message comprises a userID and a hand-up identifier of a participant;
the hand-up cancellation message comprises the userID and a hand-up cancellation identifier of the participant.

3. A hand-up interactive system in a multi-party video activity, the system comprising:
a hand-up initiating module configure to send a hand-up message and update a hand-up status in a local video window and hand-up statuses in a local roster when a hand-up button is pressed; start countdown when the hand-up button is released; if the hand-up button is pressed again within the countdown time, the hand-up initiating module restarts the countdown without sending a hand-up message; otherwise, send a hand-up cancellation message and update the hand-up status in the local video window and the hand-up statuses in the local roster at the end of the countdown; and
a hand-up responding module configured to light up a hand-up button and keep the button flashing when receiving a hand-up message; search, in a hand-up list, for userID in the hand-up message; if the userID of a participant is not found, insert the userID of the participant to the end of the hand-up list; otherwise, update the hand-up list; and determine a participant to be put on stage by pressing the hand-up button or clicking an entry in the hand-up list once, and display the participant's video; and the hand-up responding module is further configured to receive the hand-up cancellation message, and change the hand-up status of the first participant corresponding to the userID in the hand-up list to a no hand-up status based on the userID in the hand-up cancellation message; wherein
the hand-up message comprises the userID and a hand-up identifier of the first participant;
the hand-up cancellation message comprises the userID and a hand-up cancellation identifier of the first participant.
